(19) United States
(12) Patent Application Publication
(10) Pub. No.: US 2010/0289647 A1
(43) Pub. Date: Nov. 18, 2010

(54) Detection of Changes in Fasteners or Fastened Joints

(75) Inventors: Dickory Rudduck, Chicago, IL (US); Lee Blattmann, New South Wales (AU)

Correspondence Address: TELEZYGOLOGY, INC., 520 W. ERIE STREET, SUITE 100, CHICAGO, IL, 60654, US

(73) Assignee: Telezygology, Inc., Chicago, IL (US)

(21) Appl. No.: 12/595,599

(22) PCT Filed: Apr. 14, 2008
(86) PCT No.: PCT/US08/60171

§ 371 Date: Oct. 12, 2009

Related U.S. Application Data
(60) Provisional application No. 60/911,420, filed on Apr. 12, 2007.
(60) Provisional application No. 60/916,721, filed on May 8, 2007.
(60) Provisional application No. 60/941,855, filed on Jun. 4, 2007.

(51) Int. Cl. G08B 13/14

(52) U.S. Cl. 340/572.1

(57) ABSTRACT

This invention relates to the use of a tag device 4 such as a RFID tag 4 communicating with a master tag for indicating acceptable or not acceptable states of a fastener 12, fastened joint 12a, or an assembled product. It is desirable to have a way of learning of a loosened or damaged fastened joint 12a or fastener 12 immediately, for safety or security purposes. This invention can indicate to a user by remote activation when a change in a fastened joint 12a or fastener 12 is present by attaching at least one tag device 4 utilizing go/no go sensing to the fastened joint 12a or fastener 12 and using a device 14 capable of receiving signals from the tag device 4.

### FIELD OF THE INVENTION

This invention relates to the use of tagging devices with fasteners. More specifically, it relates to the use of a tag such as a RFID tag communicating with a master tag for indicating acceptable or not acceptable states of a fastener, fastened joint, or an assembled product.

### BACKGROUND OF THE INVENTION

The invention covers a system and method useful for monitoring assembled products, fasteners, fastening systems, fastener assemblies and related areas. It represents an improvement over prior art methods and systems of monitoring fasteners and fastener assemblies, etc.

Monitoring the status of a fastener, i.e. whether it is tightened, whether it has become loose or damaged, external conditions, etc., is commonly done manually. A technician will inspect fasteners on a car, airplane, wall panel, etc. by using a gauge to check tension. This process is very time consuming and thereby costly in situations where fasteners must be checked often after normal use. For example, on an aircraft, there are many fasteners included in the parts of the airplane, many of which are inaccessible or difficult to reach easily. During normal use of the aircraft, fasteners may loosen or become damaged, sometimes by corrosion, for example. Technicians must manually inspect each and every fastener on a set schedule to ensure proper performance. Every inspection costs airlines a significant amount of time and money. Therefore a method of inspection that cuts the time expended in this process is needed. This invention is aimed at providing such a solution for the aerospace and other industries.

RFID technology has been available for some time. The technology utilizes a tag with a computer chip and a radio antenna to store and relay data. A reader collects the information from the tag and provides a user with the information that is needed. Some tags have read-only capabilities while other have read/write capabilities. Current trends in the technology concentrate on the supply chain management; for example, the tracking of stock from the point of origin to the destination point. This technology allows users to increase security, track shipments, monitor external conditions, etc. While these tags are effective in performing these duties, current technology has not expanded beyond the supply chain. This invention utilizes technology including RFID technology on fasteners and assembled products in monitoring performance capabilities.

### SUMMARY OF THE INVENTION

In a first aspect this invention relates to a tagging system for detecting a change in the relationship of a first element and a second element, the system including: at least one tag device capable of emitting a signal and adapted to be affixed to the first and second elements such that a selected amount of movement between the first element and the second element is capable of damaging or disabling the tag device to render the tag device incapable of emitting an acceptable identifying signal to an interrogation device; and

a master tag adapted to communicate with the tag device.

In a second aspect this invention relates to a system for detecting a change in the relationship of a first element and a second element, the system including: at least one tag device capable of emitting a signal; a device capable of interrogating the tag device and receiving an emitted signal from the tag device; and a master tag adapted to communicate with the tag device; wherein the tag device is adapted to be affixed to the first and second elements, such that a selected amount of movement between the first element and second element is capable of damaging or disabling the tag device to render the tag device incapable of emitting an acceptable identifying signal.

In a third aspect this invention relates to a method for detecting a change in a fastener or fastening joint having first and second elements, the method including the steps of: affixing at least one tag device to the first and second elements, the tag device being capable of emitting a signal; linking the or each tag device with a master tag adapted to communicate with the or each tag device; interrogating the or each tag device for receipt of the emitted signal; and detecting a change of state of the fastener or fastening joint when the tag device fails to emit an acceptable identifying signal.

In a fourth aspect this invention relates to a tag device capable of emitting a signal and adapted to be affixed to first and second elements, such that a selected amount of movement between the first element and the second element is capable of damaging or disabling the tag device to render the tag device incapable of emitting an acceptable identifying signal to an interrogation device; wherein the tag device is adapted to provide information to a master tag.

In situations where fastened joints or fasteners can loosen over time, even during normal activity, it is desired to have a way of learning of a loosened or damaged fastened joint or fastener immediately, for safety or security purposes. This invention can indicate to a user by remote activation when a change in a fastened joint or fastener is present by attaching at least one tag device utilizing go/no go sensing to the fastened joint or fastener and using a device capable of receiving signals from the tag device. Fastened joints or fasteners may include assembled products.

Tags devices are preferably radio frequency identification (“RFID”) tags. For convenience the description below will focus on RFID tags. One skilled in the art will recognize that the tag device may also includes a surface acoustic wave transponder or a frequency doubling diode/antenna device. However, for clarity in describing this invention the tag device will be referred to as an RFID tag. It is to be understood that the invention is not limited to RFID tags.

RFID tags are commonly used to store and/or remotely retrieve information on a product, animal, or even a person, using radio waves. There are presently two types of RFID tags, passive tags and active tags. Passive tags have no internal power supply and must rely on an external power source. Active tags may have their own internal power source. The frequency of both types of tags is then turned on by a reader. The chip inside the tag responds to the reader with a frequency wave that has information available for the user to read.

This invention refers to the joining of parts generally. One skilled in the art will recognize that a wide variety of fastened joints or fasteners may be appropriate within the realm of this invention.

In this invention is generally preferable to use a tag device, like the RFID tag, affixed in a location that is more vulnerable to the detection of the position of the fastened joint or fastener. This position must be in a position where the loosened or damaged fastened joint or fastener can be sensed. Damage to a fastener or fastened joint can be caused by corrosion, heat, water, etc.

The RFID tag is preferably affixed using adhesive, such as glue or tape that is appropriate for the setting. The RFID tag in the vulnerable position is to be placed with one end on the fastener and the other end on the item being fastened or between the two parts of a fastened joint. The RFID tag may have a fracture or weakness point, for example between the chip and the antenna, but one skilled in the art will recognize that this is not necessary. This fracture point may make it easier for the RFID tag to tear and break the antennae when a fastened joint or fastener is loosened.

In an acceptable state, the RFID tag will be intact between the elements of a fastened joint or fastener. A user wishing to check the status of fastened joints or fasteners will use the device capable of receiving RFID tag signals to determine if fastened joint or fasteners are in place. While in an acceptable state, the RFID tag will respond with an acceptable identifying signal; this will be received on the user's device for receiving such signal and will indicate the “go” status. If the RFID tag is torn when the device attempts to locate the signal, the device will not receive a response and the user will immediately know to investigate that fastened joint or fastener. Fastened joints or fasteners sending an acceptable state status can be ignored and time spent checking or repairing a fastened joint or fastener will be spent more appropriately on fastened joint or fasteners in a not acceptable state.

One skilled in the art will recognize that the tag device is capable of emitting the signal optically, acoustically, thermally or using ionizing radiation depending on the tag device used. It will also be recognized that the tag device is capable of emitting the signal continuously, periodically, randomly or to a defined schedule depending on a user's needs.

The reading of acceptable/not acceptable states may be dependant on a variety of agents that serve as measurements. Some examples may include measurements such as strain, de-lamination, etc. within a composite panel section of an aircraft, movement across the joined parts, rotation can be sensed between a nut and bolt, vibration can be sensed on a wheel axle, corrosion can be sensed on a fastener in a aircraft seat, power can be checked across the power supply, time can be recorded, etc. These RFID tags can provide a great number of measurements in determining acceptable/not acceptable states.

The device for receiving RFID tag signals may be a stand-alone device or may be incorporated within other devices. This device is a reader that can tell a user additional details beyond simple acceptable/not acceptable states. It can signal details about the fastened joint or fastener such as the last time it was checked, whether or not it has been fixed before, who has checked the fastened joint or fastener, corrosion, temperature, tampering, humidity, etc. One skilled in the art will recognize that there are a wide variety of functions that can be detailed for a user.

This invention is can be easily used within an array of fastened joints or fasteners. In this situation, a single RFID tag will act as a master RFID tag. This master RFID tag may have readable and writeable qualities. In this setting, an RFID tag will still be attached to each fastened joint or fastener as described above and this RFID tag will still communicate with a user device for receiving the signals, however, this device will also communicate with the master RFID tag, for reference purposes and may be readable and writeable to update the status on a level to record the history of all the fastened joint or fasteners in the array.

This master RFID tag needs to be affixed in an area that is not vulnerable to movement and needs to be protected from elements that may inflict damage upon it. Using a master RFID tag system, a user can easily scan an area and anticipate feedback from all fastened joint or fasteners at once. This saves time, money, and manpower over existing processes.

One skilled in the art will recognize that this invention of using RFID tags in fasteners or fastened joints will most likely result in the tags being used on assembled products. An assembled product may be a wall panel in aircraft. Wall panels may be equipped with an RFID tag to indicate whether or not the panel has been tampered with. If a wall panel has been removed by an unauthorized person, such as one wishing to store contraband, then the RFID tag will be destroyed and will send information to the reader indicating that it has been removed. An assembled product may include an aircraft cockpit panel. Cockpit panels are subject to tampering and theft and RFID tags can give information to a user ensuring that the original equipment is still present. If an unacceptable state signal is received then the user is aware that tampering or other damage has occurred. An RFID tag can also be affixed to equipment such as a fire extinguisher to indicate possible tampering. If a critical seal on the fire extinguisher is affixed with an RFID tag is broken, then the RFID tag will indicate a not acceptable signal. A box or package wrapping can be an assembled product. An RFID tag can be affixed on the seal. Once the seal is broken thereby breaking the RFID tag then no frequency can be read, then a user will know that something is amiss. Another example of an assembled product could be a TV, power tool, stereo, etc. An RFID tag can be affixed to indicate warranty information, first time of use, hours in use, etc. This list of possible assembled products is infinite.

One skilled in the art will recognize that the above situations describe settings whereby the RFID tag is destroyed. However, it is possible that the tag is not completely destroyed when a fastener or fasten joint is damaged. The RFID tags may comprise an element that can be restored when the original condition is re-established.

Printed RFID tags are technically possible at this time. This invention may utilize rolls of RFID tags whereby individual tags are placed across fixed joints to detect movement of the joint elements in relation to each other. A strip seal may be utilized in creating a closed loop, such as through door handles, cabinet handles, across hatches, luggage, etc.

While the above descriptions detail the relationship between fasteners and fastened joints of two elements joined together, it is possible to utilize tag devices in situations not having fastened joints or fasteners to join them together, such as a case with wall panels. Two panels may be joined simply by the tag device. If either panel is moved, disturbed or otherwise tampered with, a user will know because the tagging device will be impaired.

One skilled in the art will recognize that the tag device is an RFID tag as described above or may include a surface acoustic wave transponder or a frequency doubling diode/antenna device. This RFID tag performs similarly as the RFID tag described in detail above. The tag device emits a signal at a range of frequencies or emits a signal optically, acoustically, thermally or using ionizing radiation that is capable of being interrogated by a reader. Once the tag device is interrogated, it will notify the user is a change is detected in the fastener or fastened joint.

Other advantages and aspects of the present invention will become apparent upon reading the following description of the drawings and the detailed description of a preferred embodiment of the invention.

### DETAILED DESCRIPTION OF THE DRAWINGS

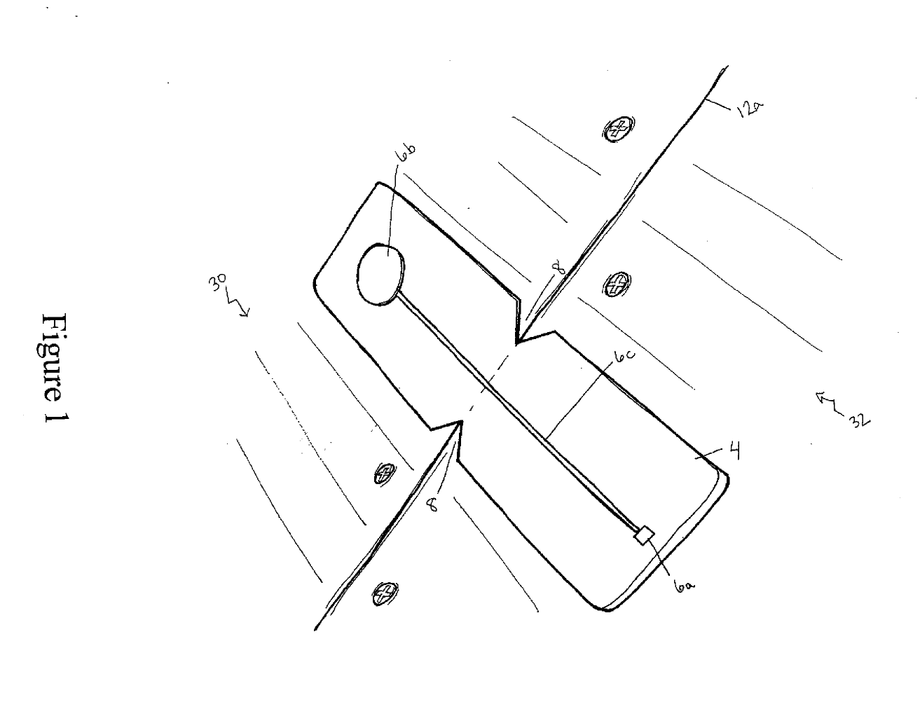

FIG. 1 depicts a detailed view of a tag device, namely the RFID tag.

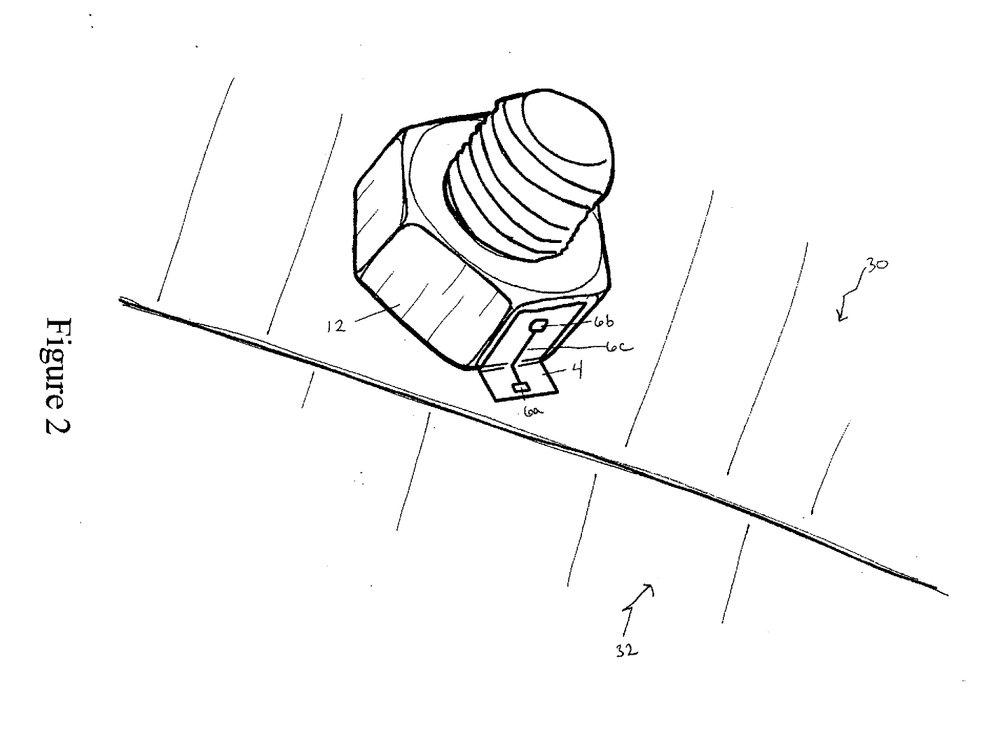

FIG. 2 depicts a bolt coupled with RFID tags.

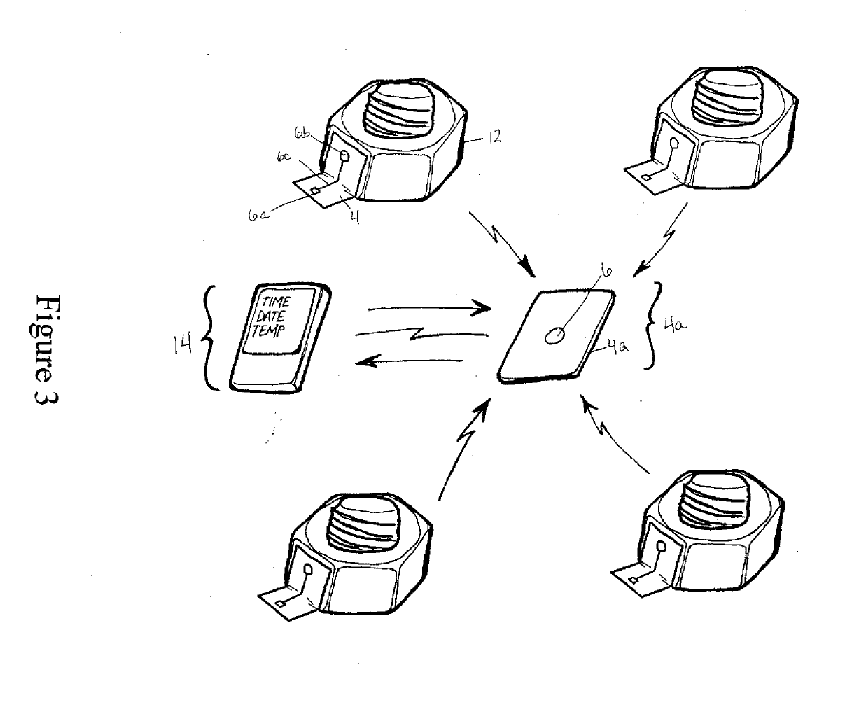

FIG. 3 depicts an array of fastened joints or fasteners controlled by a master RFID tag.

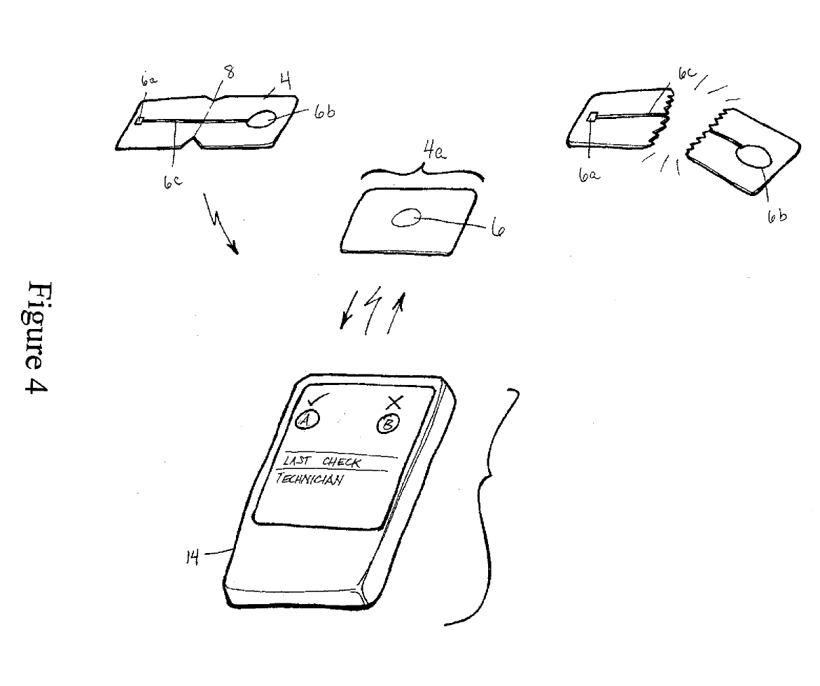

FIG. 4 depicts a setting in which an RFID tag is reporting a not acceptable state.

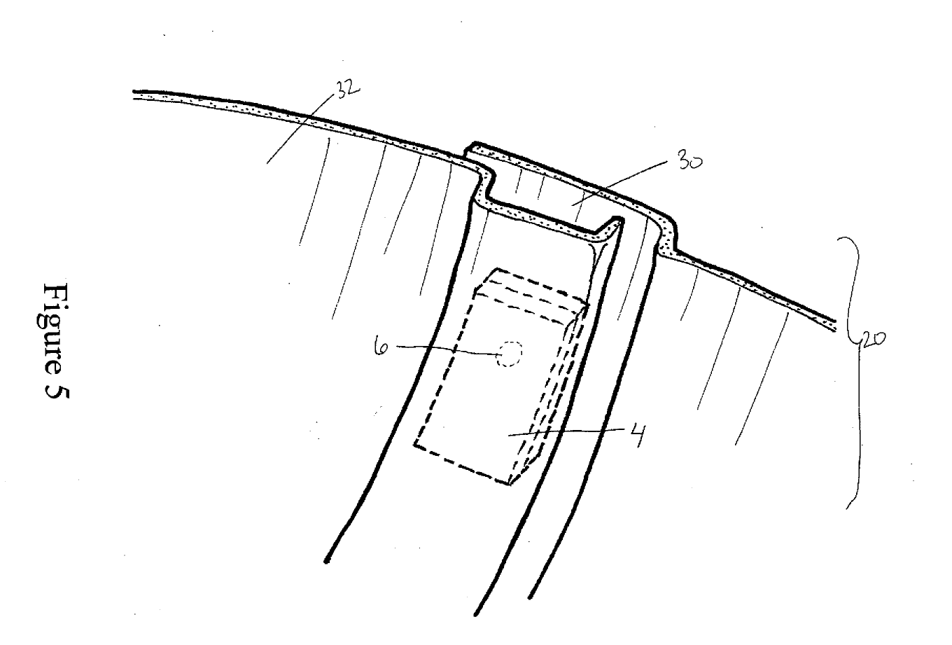

FIG. 5 depicts a removable wall panel.

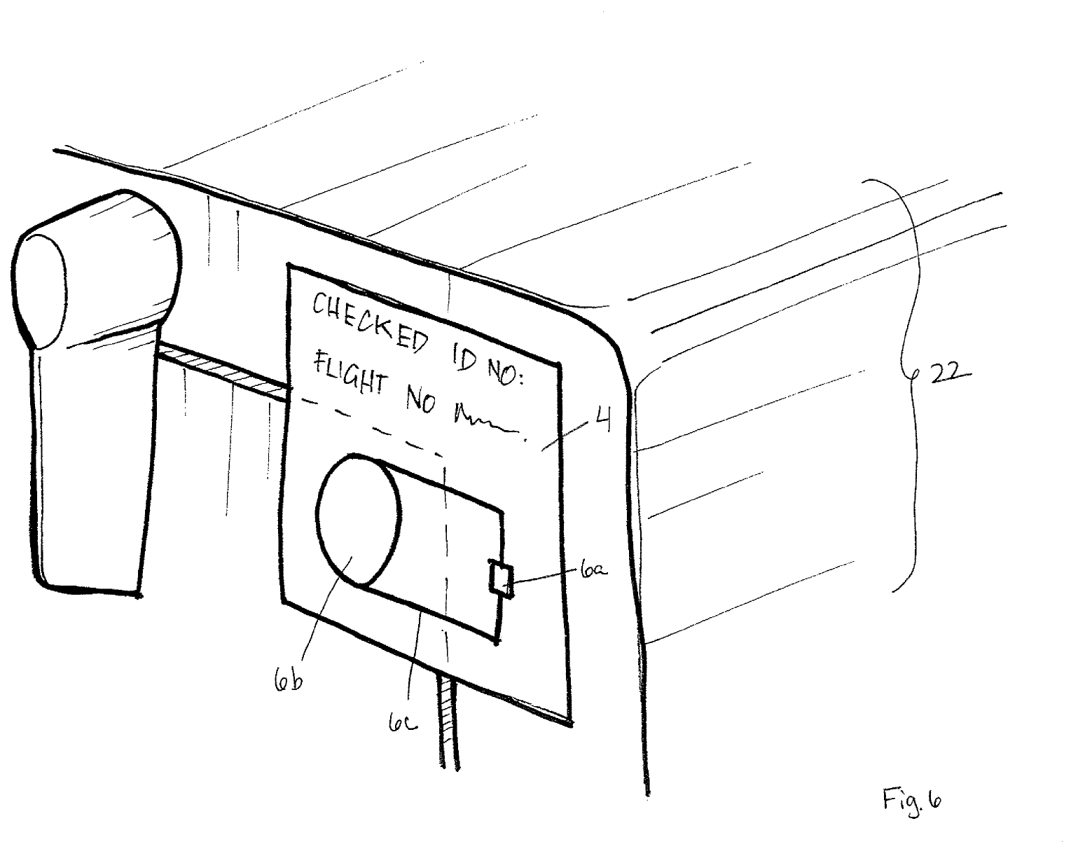

FIG. 6 depicts a cabinet affixed with an RFID tag across a critical seal.

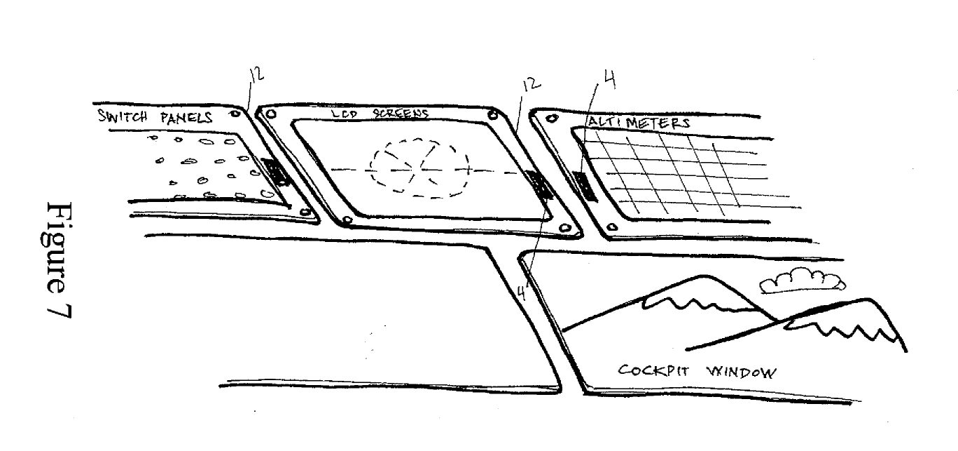

FIG. 7 depicts a cockpit panel affixed with an RFID tag across critical seal points.

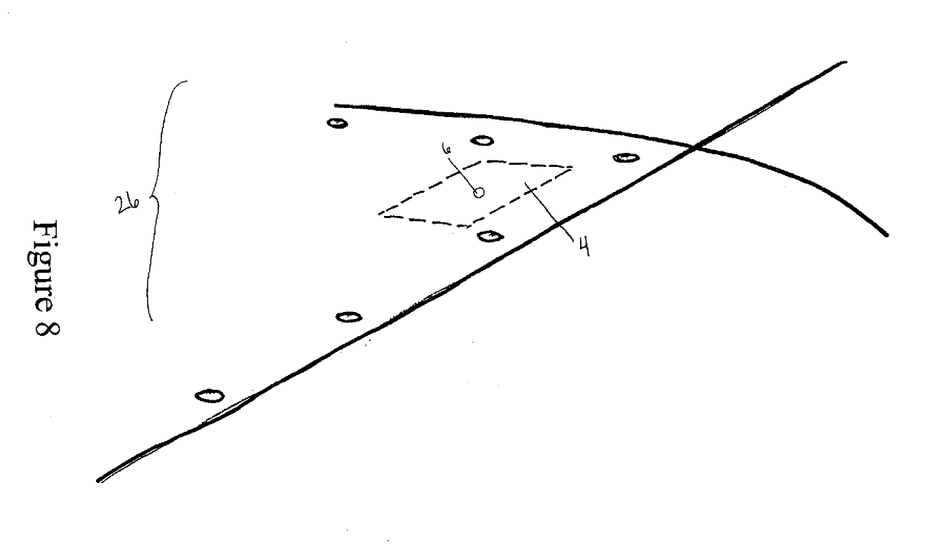

FIG. 8 depicts embedded RFID tags in composite panel sections.

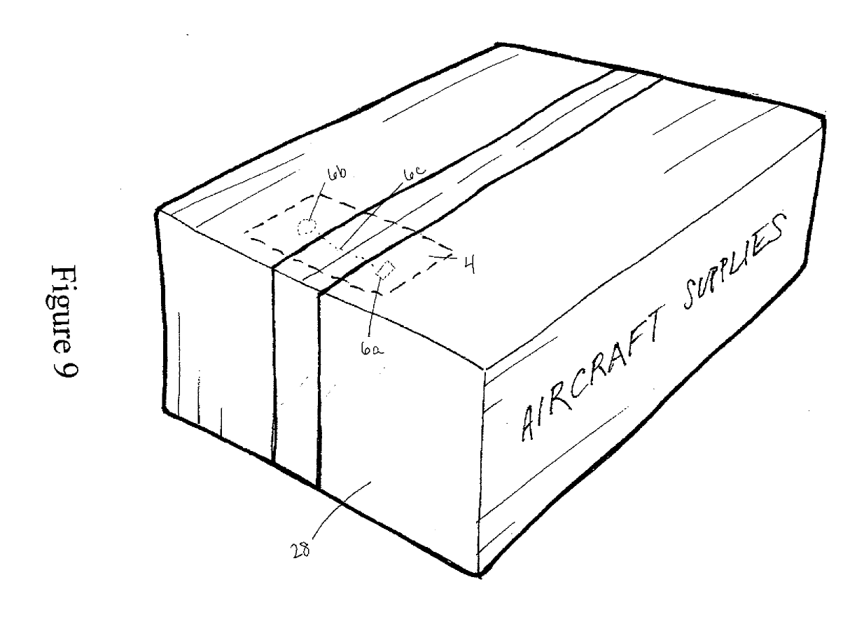

FIG. 9 depicts a container affixed with an RFID tag across a critical seal.

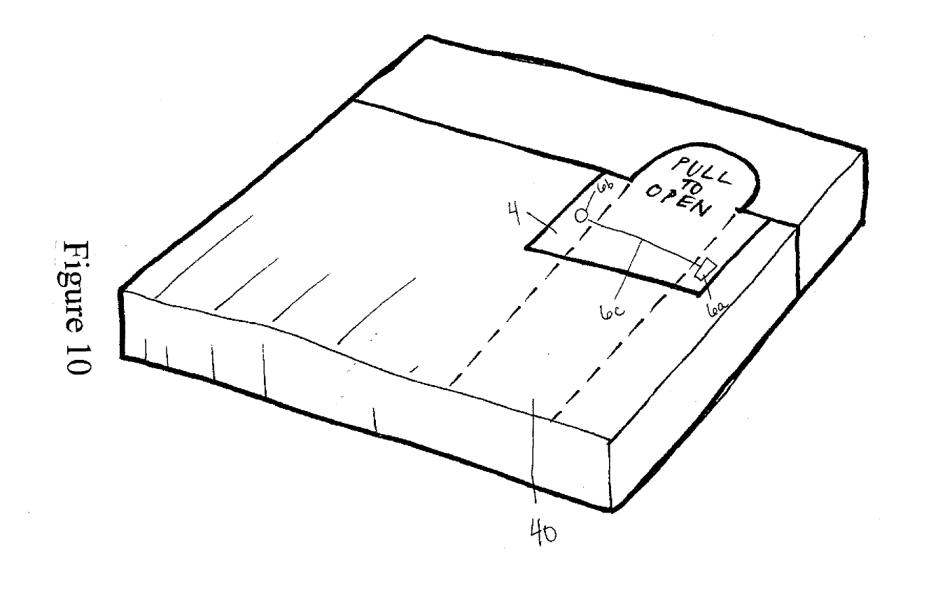

FIG. 10 depicts packaging affixed with an RFID tag across a critical seal.

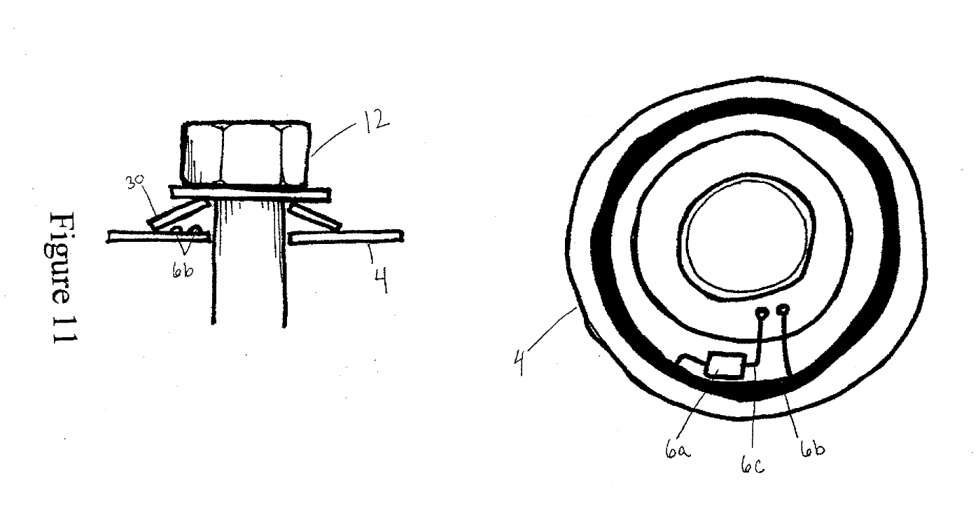

FIG. 11 depicts a situation in which the RFID tag functionality can be restored.

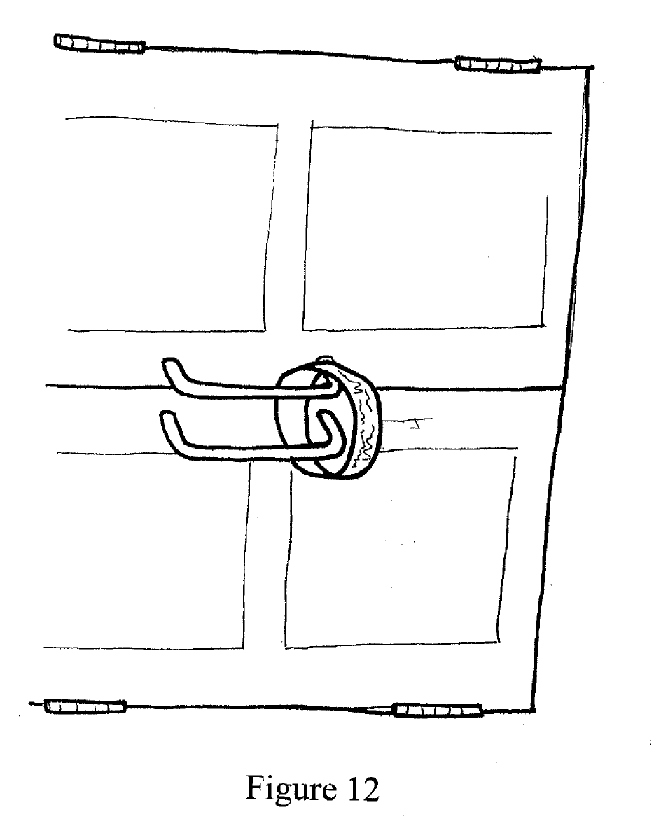

FIG. 12 depicts a strip seal.

### DETAILED DESCRIPTION OF THE PREFERRED EMBODIMENT

This invention relates to the system for detecting a change in a fastener or fastened joint, the system including: at least one fastener 12 or fastened joint 12a having a first element 30 and a second element 32; at least one tag device 4 capable of emitting a signal; and a device 14 capable of interrogating the tag device 4 and receiving a signal emitted from the tag device; wherein the tag device 4 is adapted to be affixed to the fastener 12 or fastened joint 12a, such that a selected amount of movement between the first element 30 and the second element 32 is capable of damaging or disabling the tag device 4 to render the tag device incapable of emitting the signal.

FIG. 1 depicts a tag device 4, here an RFID tag 4, coupled with electronics 6 including a chip 6A and antennae 6b joined by conductive wire 6c. This RFID tag 4 also comprises a fracture point 8. Adhesive 10 is on the back of the RFID tag 4 and will hold one end to the fastener 12 (as seen in FIG. 2) and the other end to the elements 30, 32.

When the RFID tag 4 is intact on the fastener 12, the electronics 6 within the RFID tag 4 will send an acceptable state signal to the device 14 capable of receiving the signal. If the fastener 12 loosens or becomes damaged in any way, the RFID tag 4 will tear. The fracture point 8 is present to make the RFID tag 4 more sensitive to movement of the bolt 12. When the RFID tag 4 is torn, the device capable of receiving the signal will detail a not acceptable state.

This invention may also be used within an array of fastened joint or fasteners as seen in FIGS. 3 and 4. In FIG. 3, there is a master RFID tag 4a located in a secure, non-vulnerable area. This master RFID tag 4a is readable and writeable is a repository for information from the bolts and their corresponding RFID tags 4 and then sends and/or is interpreted by a device that can read the master RFID tag 4a.

The master tag 4a may be connected to the or each tag device in any suitable way. In the case of several tag devices, preferably these form a star network, with the master tag 4a at the centre. Other configurations are possible.

Each tag device may include or be associated with a sensor or other device able to convey to the master tag information as to the condition of the tag device; including sensing in order to report degradation, exposure to extremes of temperature, corrosion, humidity etc. There may also be tracking of events in relation to a tag device. For example, each access to a tag device may be recorded in a time stamped log stored by the master tag 4a or by the tag device itself or by intermediate system elements. Retrieval of such logs can permit analysis for audit tracking purposes. Temperature sensors or equivalent temperature sensing devices can be used to sense the temperature of the tag device. Other examples of sensors will be apparent to one skilled in the art.

Sensors can enable reports as to tag device history and condition to one or more master tags in a network. A sensor may be a local temperature probe, which can sense ambient temperature and report to an embedded processor.

FIG. 4 depicts a situation whereby one of the fasteners 12 has been loosened or damaged. RFID tag A sends a signal to the master RFID tag 4a that it is in an acceptable state. This is noted on the device 14. RFID tag B sends no signal indicating that it must have torn due to loosening or fastening on its corresponding bolt 12. A user of the device 14 now knows that B needs repair and it can quickly determine the source of the problem. FIG. 5 details a wall panel 20 with embedded RFID tags 4. In this situation, there is no fastener or fastened joint. This preferred embodiment simply comprises at least one tag device 4 capable of emitting a signal; and a device 14 capable of interrogating the tag device 4 and receiving an emitted signal from the tag device 4 wherein the tag device 4 is adapted to be affixed to the first element 30 and second element 32, such that a selected amount of movement between the first element 30 and the second element 32 is capable of damaging or disabling the tag device to render the tag device incapable of emitting the signal.

If the wall panel 20 is removed, then the RFID tag 4 is broken. If the wall panel 20 was not removed by an authorized person, then routine checks of the wall panel 20 will indicate this by way of no signal being received. Authorized persons will be able to remove a wall panel 20 and then replace the RFID tag 4 to create a secure atmosphere.

FIG. 6 details a cabinet 22 with an RFID tag 4 over a critical sealing point. If the cabinet is tampered with, the RFID tag 4 will break. It is unlikely that an unauthorized person will be able to repair the RFID tag 4 and routine checks will indicate a broken fastened joint 12.

FIG. 7 details a cockpit panel 24 with an RFID tag 4 over a critical fastened joining points 12. If an unauthorized person tries to remove the panel for purposes of theft or tampering, then the RFID tag 4 will be broken across the fastened joint area. Again, routine checks by authorized persons would quickly notice this situation by using the appropriate reader 14.

FIG. 8 details RFID tags 4 embedded in composite panel sections 26 on an aircraft. These RFID tags 4 can operate alone or in a series with a master RFID tag. They can report sensing conditions such as stress or joint movement in addition to typical security reports.

FIG. 9 details a container 28 whereby the RFID tag 4 is internal and includes an internal packaging date. Once the container is opened, the RFID tag 4 is destroyed. FIG. 10 is a similar application to that seen in FIG. 9. The RFID tag 4 is internal to external product packaging 40 and is destroyed if the package is opened.

FIG. 11 details a unique situation whereby the RFID tag 4 capabilities are not destroyed in a changed condition but instead are restorable. As seen in FIG. 11, the fastener 12 comprises a contact washer 30. When the fastener 12 is in its original, desired condition, the antennae 6b of the RFID tag 4 are in contact with the contact washer 30. If the fastener 12 is loosened, then the contact is lost with the contact washer 30. Once contact can be made again, the RFID tag 4 capabilities are re-established.

The invention may be described in terms of claims that can assist the skilled reader in understanding the various aspects and preferments of the invention. It will be appreciated by those skilled in the art that many modifications and variations may be made to the embodiments described herein without departing from the spirit and scope of the invention.

1. A tagging system for detecting a change in the relationship of a first element and a second element, the system including:
at least one tag device capable of emitting a signal and adapted to be affixed to the first and second elements such that a selected amount of movement between the first element and the second element is capable of damaging or disabling the tag device to render the tag device incapable of emitting an acceptable identifying signal to an interrogation device; and
a master tag adapted to communicate with the tag device, wherein the master tag is adapted to store signals emitted from the tag device.

2. The system of claim 1, wherein the first and second elements are parts of a fastener or fastened joint.

3. The system of claim 2, wherein the interrogation device is adapted to receive from the tag device or from the master tag information about the fastener or fastened joint; the interrogation device includes a stand-alone device and/or may be combined with other devices.

4. The system of claim 3, wherein the information is chosen from one or more of the following: last occasion on which the fastener or fastened joint was checked, last occasion on which the fastener was fastened or the fastened joint was fixed, identity of a person authorizing fastening of the fastener or fixing of the fastened joint, exposure of the tag device or master tag to temperature or humidity and corrosion to the tag device or master tag.

5. The system of any one of claim 4, wherein the tag device is adapted to be rendered incapable of emitting the acceptable identifying signal by physical damage to or disablement of an element of the tag device; said element of tag device is an antenna or electrical wiring.

6. The system of claim 5, wherein the damage to or disablement of the element of the tag device is adapted to be reversible by restoring the damaged or disabled element.

7. The system of claim 1, wherein the master tag is writeable to record status or update history of the tag device.

8. The system of claim 1, wherein the tag device includes:
first and second ends;
an area of weakness lying between the first and second ends; and
an antenna for the tag device running through the area of weakness,
wherein the first end of the tag device is adapted to be affixed to the first element and the second end of the tag device is adapted to be affixed to the second element.

9. The system of any one of claim 1, wherein the tag device is an RFID tag device.

10. The system of claim 1, wherein the tag device includes a surface acoustic wave transponder or a frequency doubling diode/antenna device.

11. The system of claim 10, wherein the tag device is capable of emitting the signal on a range of frequencies optically, acoustically, thermally or using ionizing radiation on a continuous, periodic, random or to a defined schedule.

12. A system for detecting a change in the relationship of a first element and a second element, the system including:
at least one tag device capable of emitting a signal;
a device capable of interrogating the tag device and receiving an emitted signal from the tag device; and
a master tag adapted to communicate with the tag device, wherein the master tag is adapted to store signals emitted from the tag device;
wherein the tag device is adapted to be affixed to the first and second elements, such that a selected amount of movement between the first element and second element is capable of damaging or disabling the tag device to render the tag device incapable of emitting an acceptable identifying signal.

13. The system of claim 12, wherein the first and second elements are parts of a fastener or fastened joint.

14. The system of claim 13, wherein the interrogation device is adapted to receive from the tag device or from the master tag information about the fastener or fastened joint; the interrogation device includes a stand-alone device and/or may be combined with other devices.

15. The system of claim 14, wherein the information is chosen from one or more of the following: last occasion on which the fastener or fastened joint was checked, last occasion on which the fastener was fastened or the fastened joint was fixed, identity of a person authorizing fastening of the fastener or fixing of the fastened joint, exposure of the tag device or master tag to temperature or humidity and corrosion to the tag device or master tag.

16. The system of claim 15, wherein the tag device is adapted to be rendered incapable of emitting the acceptable identifying signal by physical damage to or disablement of an element of the tag device.

17. The system of claim 16, wherein the damage to or disablement of the element of the tag device is adapted to be reversible by restoring the damaged or disabled element; said element of tag device is an antenna or electrical wiring.

18. The system of claim 12, wherein the master tag is writeable to record status or update history of the tag device.

19. The system of claim 12, wherein the tag device includes:
first and second ends;
an area of weakness lying between the first and second ends; and
an antenna for the tag device running through the area of weakness,
wherein the first end of the tag device is adapted to be affixed to the first element and the second end of the tag device is adapted to be affixed to the second element.

20. The system of claim 12, wherein the tag device is an RFID tag device.

21. The system of claim 12 wherein the tag device includes a surface acoustic wave transponder or a frequency doubling diode/antenna device.

22. The system of claim 21, wherein the tag device is capable of emitting the signal on a range of frequencies optically, acoustically, thermally or using ionizing radiation on a continuous, periodic, random or to a defined schedule.

23. A method for detecting a change in a fastener or fastening joint having first and second elements, the method including the steps of:
affixing at least one tag device to the first and second elements, the tag device being capable of emitting a signal;
linking the or each tag device with a master tag adapted to communicate with the or each tag device;
interrogating the or each tag device for receipt of the emitted signal; and
detecting a change of state of the fastener or fastening joint when the tag device fails to emit an acceptable identifying signal.

24. A tag device capable of emitting a signal and adapted to be affixed to first and second elements, such that a selected amount of movement between the first element and the second element is capable of damaging or disabling the tag device to render the tag device incapable of emitting an acceptable identifying signal to an interrogation device; wherein the tag device is adapted to provide information to a master tag.

25. The tag device of claim 24, wherein the first and second elements are parts of a fastener or fastened joint.

26. The tag device of claim 25, wherein the information is chosen from one or more of the following: last occasion on which the fastener or fastened joint was checked, last occasion on which the fastener was fastened or the fastened joint was fixed, identity of a person authorising fastening of the fastener or fixing of the fastened joint, exposure of the tag device to temperature or humidity and corrosion to the tag device.

27. A tag device capable of emitting a signal and adapted to be affixed to first and second elements, such that a selected amount of movement between the first element and the second element is capable of damaging or disabling the tag device to render the tag device incapable of emitting an acceptable identifying signal to an interrogation device; wherein the tag device is adapted to be rendered incapable of emitting the acceptable identifying signal by physical damage to or disablement of an element of the tag device and the damage to or disablement of the element is adapted to be reversible by restoring the damaged or disabled element.

28. The tag device of claim 27, wherein the element is an antenna or electrical wiring.
